(19) United States
(12) Patent Application Publication
(10) Pub. No.: US 2012/0089283 A1
(43) Pub. Date: Apr. 12, 2012

(54) OPERATING METHOD FOR A HYBRID VEHICLE

(75) Inventors: Thomas Rauner, Blaubeuren (DE); Heiko Mayer, Adelmannsfelden (DE); Philipp Söll, Blaubeuren (DE)

(73) Assignee: Dr. Ing. h.c. F. Porsche Aktiengesellschaft, Stuttgart (DE)

(21) Appl. No.: 13/248,574

(22) Filed: Sep. 29, 2011

(30) Foreign Application Priority Data
Oct. 6, 2010 (DE) 102010038010.5

(51) Int. Cl. B60W 20/00

(52) U.S. Cl. 701/22; 180/65.285; 903/906

(57) ABSTRACT

An operating method for a hybrid vehicle having an electric motor and an internal combustion engine, in which driving, in particular a start of a journey, occurs in a purely electric-motor mode if a velocity (v_{F}) drops below a predefined limiting value, a temperature (T_{B}) of a vehicle battery drops below a predefined limiting value, a driver's request torque (M_{F})/activation of an accelerator pedal drops below a predefined limiting value, and a state of charge (SOC) of the vehicle battery exceeds a predefined limiting value, to allow for starting situations in residential areas or underground parking garage.

### CROSS-REFERENCE TO RELATED APPLICATION

This U.S. patent application claims priority to German Patent Application DE 10 2010 038 010.5, filed Oct. 6, 2010, which is incorporated by reference herein in its entirety.

### FIELD OF THE INVENTION

The present invention relates to an operating method for a hybrid vehicle having an electric motor and an internal combustion engine. The invention also relates to a hybrid vehicle which is operated with such an operating method.

### BACKGROUND OF THE INVENTION

In hybrid vehicles which are currently commercially available, in particular in the event of a cold start, the internal combustion engine is usually started immediately in order to be able to bring about rapid heating of the internal combustion engine, and associated therewith rapid heating of a catalytic converter, which permits the increasingly stringent exhaust gas standards to be met. In particular the catalytic converter requires, for optimum operation, a predefined limiting temperature below which it cannot make the pollutants present in the exhaust gases nondamaging or can only do so to an inadequate degree. For this reason, as already mentioned at the beginning, in the known hybrid vehicles the internal combustion engine is always started at the start of the journey.

U.S. Pat. No. 6,735,502 B2, which is incorporated by reference herein, discloses an operating method for a hybrid vehicle in which different operating states are assigned different engine operating states.

EP 2 199 170 A1, which is incorporated by reference herein, discloses a hybrid vehicle having what is referred to as a start/stop system.

As has already been mentioned at the beginning, in conventional hybrid vehicles the internal combustion engine is started immediately at the start of the journey, but under certain circumstances this can be disadvantageous. Consideration is to be given in this context to, in particular, situations in which a car is driven out of an underground parking garage which situations require a comparatively low drive torque but also require that the pollutant load in the air within the underground parking garage to be kept as low as possible in order, in particular, to prevent damage to health, or at least to be able to reduce said damage. In addition, in these conventional hybrid vehicles, the driving experience at the start of a journey is not different from that in a conventional vehicle with an internal combustion engine.

### DESCRIPTION OF THE INVENTION

The present invention is concerned with the problem of specifying an operating method for a hybrid vehicle which allows, in particular, for individual operating states at the start of a journey to be taken into account.

This problem is solved according to aspects of the invention by means of the subject matter of the independent claims. Advantageous embodiments are the subject matter of the dependent claims.

The present invention involves the general idea of operating a hybrid vehicle with an electric motor and an internal combustion engine exclusively in a purely electric-motor mode after a cold start or after a warm start if a series of criteria for this are met. These criteria are, for example, that a velocity drops below a predefined value, that a temperature of a vehicle battery drops below a predefined value, that a driver's request torque drops below a predefined value and/or the activation of an accelerator pedal drops below a predefined value, and that a predefined state of charge of the vehicle battery is exceeded. The definition of these four criteria therefore permits the hybrid vehicle to be started in a purely electric-motor mode, which significantly improves, in particular, specific driving situations such as, for example, driving out of an underground parking garage, in terms of emissions of pollutants. Furthermore, the operating method according to aspects of the invention also improves the start of a journey within a residential area since this can now be carried out, in contrast to previous hybrid vehicles, in a purely electric-motor mode and therefore comparatively quietly. As a result, in particular it is possible to allow also for an increased requirement for quiet within residential areas, and the driving experience in the electric-motor mode in a hybrid vehicle can be improved.

In one advantageous development of the solution according to aspects of the invention, the limiting value for the velocity is approximately 50 km/h. The hybrid vehicle according to aspects of the invention is therefore started in a purely electric-motor mode only when the velocity is below 50 km/h. In the driving situations described in the previous paragraph, such as for example driving out from an underground parking garage or from a residential area, this velocity threshold is usually not exceeded, with the result that the internal combustion engine does not necessarily have to be started. This limiting value can also be provided in a chronologically variable fashion in order to allow for the conditions which change in the journey profile of the hybrid vehicle.

The limiting value for the temperature of the vehicle battery is expediently approximately 40° C. This can ensure that the hybrid vehicle is driven in a purely electric-motor mode exclusively when the vehicle battery has a temperature of at maximum 40°, as a result of which a further rise in the temperature of the vehicle battery, due to the electric driving state, is restricted to a bearable level, specifically, for example, the abovementioned 40° C. This can reliably rule out overheating and therefore overloading of the vehicle battery.

In a further advantageous embodiment of the solution according to aspects of the invention, the limiting value for the state of charge of the vehicle battery is approximately 45%. The hybrid vehicle therefore in turn starts in a purely electric-motor mode exclusively when the state of charge of the vehicle battery exceeds the predefined limiting value, that is to say, for example is at least 45%, that is to say approximately half. As a result, excessive discharging of the vehicle battery and the associated restrictions are to be reliably avoided. If the state of charge of the vehicle battery therefore drops below 45% of a fully charged state, the hybrid vehicle cannot be operated exclusively in electric-motor mode or in the purely electric-motor mode, the internal combustion engine is then started in order, on the one hand, to charge the vehicle battery by means of a generator, for example the dynamo, and, on the other hand, to take over or assist the drive of the vehicle. The threshold of approximately 45% therefore reliably avoids the hybrid vehicle starting in a purely electric-motor mode when the vehicle battery is too weak, as a result of which, in particular, complete discharging is prevented and therefore reliable starting of the internal combustion engine is ensured.

Drive in a purely electric-motor mode also expediently takes place exclusively when a driver's request torque and/or activation of an accelerator pedal drop below a predefined limiting value. The undershooting of this limiting value signals a restrained or normal acceleration request by the driver, which can be accepted by the electric motor without a problem. If, on the other hand, the driver depresses the accelerator pedal to a greater degree, he wishes comparatively strong acceleration, which cannot be met exclusively by the electric motor, so that in this case the internal combustion engine provides the acceleration or at least assists in accelerating the hybrid vehicle.

In a further advantageous embodiment of the solution according to aspects of the invention, the drive in the purely electric-motor mode is terminated if, for example, a vehicle door, in particular the driver's door, or a hood, in particular an engine hood, are opened. Similarly, the drive in the purely electric-motor drive can be terminated if, for example, a seatbelt, in particular the driver's seatbelt, is opened. These peripheral conditions for terminating the drive in the purely electric-motor mode serve exclusively to improve the safety of the persons traveling in the hybrid vehicle.

The hybrid vehicle according to aspects of the invention is generally operated in a purely electric-motor mode when and for as long as all the above-mentioned conditions are met.

Further important features and advantages of the invention emerge from the dependent claims, from the drawings and from the associated description of the figures with reference to the drawings.

Of course, the features which are mentioned above and which are still to be explained below can be used not only in the respectively specified combination but also in other combinations or in isolation without departing from the scope of the present invention.

Preferred exemplary embodiments of the invention are illustrated in the drawings and will be explained in more detail in the following description, wherein identical reference signs relate to identical or similar or functionally identical components.

### DESCRIPTION OF THE DRAWINGS

FIG. 1 is a schematic illustration of an operating method according to aspects of the invention,

FIG. 2 is a schematic illustration of an electric cold start in a normal driving cycle,

FIG. 3 is a schematic illustration of an extended electric cold start.

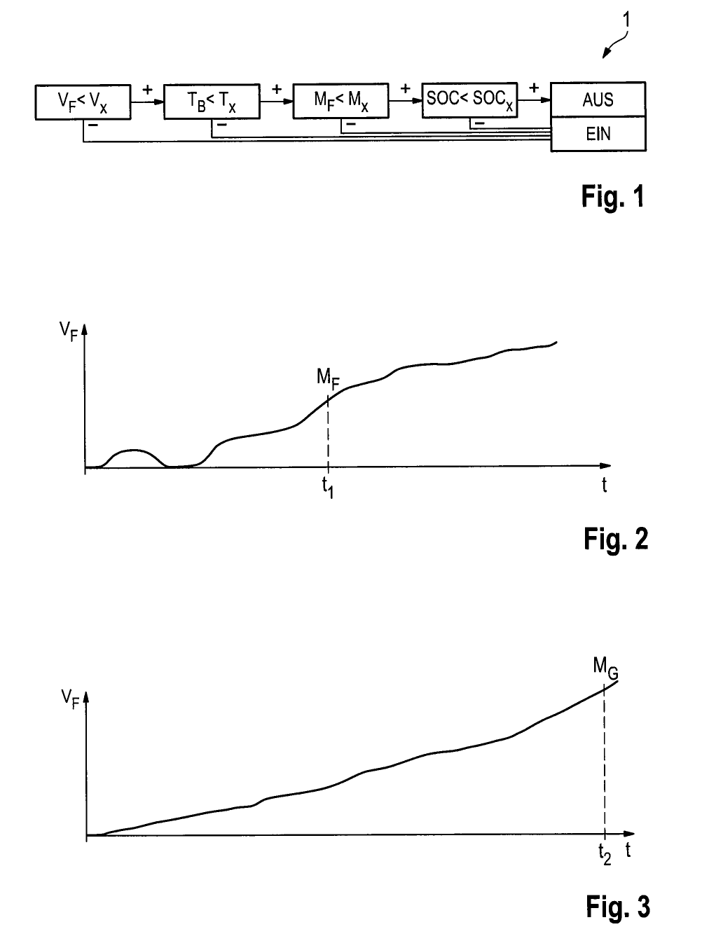

FIG. 1 shows an operating method according to aspects of the invention for a hybrid vehicle having an electric motor and an internal combustion engine 1. As is apparent from FIG. 1, the hybrid vehicle is operated in a purely electric-motor mode if a velocity v_{F}<vₓ, is present where, for example, vₓ=50 km/h, a temperature of a vehicle battery T_{B}<Tₓ, is present, where, for example, Tₓ=40° C., and a driver's request torque M_{F}<Mₓ and a state of charge of the vehicle battery SOC<SOCₓ, where, for example, SOCₓ=45%, are present. All the above-mentioned preconditions have to be met in this case for it to be possible to start or operate the hybrid vehicle in a purely electric-motor mode, that is to say to prevent the internal combustion engine 1 from being started. If, for example, the velocity is above vₓ, this condition is not met as a result of the minus sign, whereupon the internal combustion engine 1 is started. The same also applies to the temperature of the vehicle battery T_{B}, to the driver's request torque M_{F} and to the state of charge SOC of the vehicle battery. If, therefore, the state of charge SOC of the vehicle battery is, for example, less than SOCₓ, the internal combustion engine 1 is started automatically in order, on the one hand, to be able to ensure drive for the hybrid vehicle and, on the other hand, to be able to recharge the vehicle battery via a generator.

The operating method according to aspects of the invention permits here, in particular, low-pollutant starting in the case of a key start or cold start, in particular when driving out of an underground parking garage or a residential area, as a result of which, in particular, the situations in terms of pollutants and noise there are to be allowed for.

FIG. 2 shows an electric cold start as it could look in reality, as a profile of the velocity v_{F} plotted against the time t. Here, the driving of the hybrid vehicle in the purely electric-motor mode is possible up to a specific power threshold or vehicle velocity v_{F}. In such a normal driving cycle, the electric cold start, as can be seen in FIG. 1, is terminated at the time t₁ by starting the internal combustion engine 1 owing to an excessively large driver's request torque.

In contrast, FIG. 3 illustrates an extended electric cold start. By switching over, for example into an extended electric driving mode by the driver pressing an E-power key, an extended electric cold start is possible up to a maximum power limit of the system, as a result of which the driving experience in the electric-motor mode can be significantly improved. The starting of the internal combustion engine 1 is then triggered by means of the power limit of the system.

With the operating method according to aspects of the invention it is possible, in particular in contrast to previously known hybrid vehicles, to significantly reduce emission of pollutants and noise at the start of a journey.

1.-7. (canceled)

8. An operating method for a hybrid vehicle having an electric motor and an internal combustion engine, in which driving, in particular a start of a journey, occurs in a purely electric-motor mode if
a velocity (v_{F}) drops below a predefined limiting value,
a temperature (T_{B}) of a vehicle battery drops below a predefined limiting value,
a driver's request torque (M_{F})/activation of an accelerator pedal drops below a predefined limiting value, and
a state of charge (SOC) of the vehicle battery exceeds a predefined limiting value.

9. The operating method as claimed in claim 8, wherein the limiting value for the velocity (v_{F}) is between 20 km/h and 50 km/h.

10. The operating method as claimed in claim 8, wherein the limiting value for the temperature (T_{B}) of the vehicle battery is between 30° C. and 60° C.

11. The operating method as claimed in claim 8, wherein the limiting value for the state of charge (SOC) of the vehicle battery is between 40 and 60%.

12. The operating method as claimed in claim 8, wherein the drive in the purely electric-motor mode is terminated if a vehicle door is opened.

13. The operating method as claimed in claim 8, wherein the drive in the purely electric-motor mode is terminated if a seatbelt.

14. A hybrid vehicle which is operated with an operating method as claimed in claim 8.

15. The operating method as claimed in claim 9, wherein the limiting value for the velocity (v_{F}) is approximately 50 km/h.

16. The operating method as claimed in claim 10, wherein the limiting value for the temperature (T_{B}) is approximately 40° C.

17. The operating system, as claimed in claim 11, wherein the limiting value for the state of charge is approximately 45%.

18. The operating method as claimed in claim 12, wherein the vehicle door is a driver's door or a hood.

19. The operating method as claimed in claim 13, wherein the seatbelt is the driver's seatbelt.
